(19) United States
(12) Patent Application Publication
(10) Pub. No.: US 2026/0153151 A1
(43) Pub. Date: Jun. 4, 2026

(54) SHUT-OFF DEVICE WITH A BEARING DEVICE

(71) Applicant: Neoperl GmbH, Müllheim (DE)

(72) Inventors: Seoung-Eun KIM, Bad Krozingen (DE); Marc TEMPEL, Freiburg (DE); Yichao BIAN, Müllheim (DE)

(73) Assignee: Neoperl GmbH, Müllheim (DE)

(21) Appl. No.: 19/404,283

(22) Filed: Dec. 1, 2025

(30) Foreign Application Priority Data
Dec. 2, 2024 (EP) 24216884.7

(51) Int. Cl. F16K 1/44; F16K 27/02

(52) U.S. Cl. CPC F16K 1/44; F16K 27/0236

(57) ABSTRACT

A shut-off device (1), in particular a valve, for a flowable medium, having at least one closure element (3, 20) that can be moved into an open position and into a closed position, and a seat (4, 21) for the at least one closure element (3, 20), in particular a valve seat. In the shut-off device (1), an intermediate position of the closure element (3, 20) is determined by a bearing device (32, 36), in particular wherein, in the intermediate position, the closure element (3, 20) contacts the bearing device (32, 36) and/or is spaced apart from the seat (4, 21).

### CROSS-REFERENCE TO RELATED APPLICATIONS

This application claims priority from European Patent Application No. 24216884.7, filed Dec. 2, 2024, which is incorporated herein by reference as if fully set forth.

### TECHNICAL FIELD

The invention relates to a shut-off device for a flowable medium, having at least one closure element that can be moved into an open position and into a closed position, and a seat for the at least one closure element.

The invention further relates to a shut-off device actuating device with a shut-off device described herein and, in particular, to a valve actuating device with a valve described herein.

The shut-off device can be designed in particular as a valve, wherein the seat is designed as a valve seat.

### BACKGROUND

Shut-off devices are generally known from practice, for example in the form of valves, gate valves, flaps, or taps.

A shut-off device serves to release, stop, and/or throttle the flow of a flowable medium, in particular the flow of a fluid, through an opening adjacent to the seat of the shut-off device. For this purpose, a shut-off device can be brought into different states.

In an open state of a shut-off device, in particular a valve, in which a maximum flow of a flowable medium through the opening adjacent to the seat of the shut-off device is possible, the closure element is arranged in the open position. In the open position, the closure element is arranged at such a distance from the seat that a flowable medium can flow through the opening adjacent to the seat of the shut-off device without being affected or essentially unaffected by the closure element.

When a shut-off device, in particular a valve, is in the closed state, in which no flow or essentially no flow of a flowable medium is possible through the opening adjacent to the seat of the shut-off device, the closure element is arranged in the closed position. In the closed position, the closure element is arranged in such a way that it seals the seat so that a flowable medium cannot or essentially cannot flow through the opening adjacent to the seat of the shut-off device.

Shut-off devices in the form of valves that can be moved into an open or closed position are known in the prior art. For example, publications DE 195 47 222 A1,EP 0 489 331 B1, US 2021/301928 A1 and EP 0 618 988 B1 disclose such valves. It is not provided in these valves that a closure element is arranged in an intermediate position between the open position and the closed position, in which a throttled flow of a flowable medium through the opening adjacent to the seat of the shut-off device is possible.

It has been found that in a state of shut-off devices in which the closure element is arranged in an intermediate position between the open position and the closed position, in which a throttled flow of a flowable medium through the opening adjacent to the seat of the shut-off device is possible, noises are emitted from the shut-off device. This noise can be perceived as disturbing. It may therefore be desirable to avoid this noise.

### SUMMARY

The invention is based on the object of providing a shut-off device which emits no noise or reduced noise in an intermediate position of a closure element.

This object is solved by a shut-off device with one or more of the features described herein. Advantageous designs are described below and in the claims.

The features listed individually can be combined with each other in any technologically sensible way and define further designs of the invention, as long as these combinations have at least some of the features disclosed herein.

To solve the set object, the invention proposes that, in a shut-off device of the type described above, an intermediate position of the closure element is determined by a bearing device in order to solve the aforementioned object.

As described above, the closure element can thus be movable into an intermediate position between the open position and the closed position, wherein the intermediate position is defined by a functional and/or spatial relationship to the bearing device. The bearing device is a device which forms and/or has a bearing.

In particular, the closure element can contact the bearing device in the intermediate position. In other words, the bearing device can serve as a bearing for the closure element in the intermediate position.

In addition or alternatively, the closure element may be spaced apart from the seat in the intermediate position. In particular, the closure element rests on or against the bearing device in the intermediate position and does not come into contact with the seat. Preferably, the distance between the closure element in the intermediate position and the seat is 0.05 mm to 0.2 mm.

Due to the fact that the closure element in the intermediate position is spaced apart from the seat, a flowable medium can flow through the opening adjacent to the seat of the shut-off device. A predefined distance between the closure element in the intermediate position and the seat allows for reduced flow compared to the open position of the closure element. Due to the physical contact preferably existing between the closure element and the bearing device, the closure element is securely mounted and/or arranged in such a way that it can move to a limited extent and, in particular, oscillate. This greatly reduces or even eliminates noise emissions.

In practice, the shut-off device may have an actuating mechanism and/or an adjustment device with which the closure element or a component of the closure element can be brought to an adjustable distance from the seat.

The actuating mechanism can in particular serve to move the closure element between its open position and its closed position.

The adjustment device can be used in particular to move the closure element to a variably adjustable distance from the seat. This also makes it possible to move the closure element to the intermediate position using the adjustment device. By means of the adjustment device, the flow rate of the flowable medium through the opening adjacent to the seat can be adjusted by adjusting the distance of the closure element or a component of the closure element to the seat. The adjustment device can thus serve as a throttle.

The adjustment device can be designed in particular as a rotary mechanism. A rotary mechanism has a rotatable actuating means that can be operated by an operator, in particular a hand-operated element, which is connected to the closure element and/or the seat by means of a mechanical arrangement. By rotating the actuating means, the closure element and the seat are moved relative to each other.

In practice, at least one component of the closure element that can be brought into contact with the bearing device and the bearing device can be designed with different elasticities.

Elasticity is a material property that describes elastic deformability. If at least one component of the closure element that can be brought into contact with the bearing device, or the entire closure element and the bearing device, have different elasticities, one of these components is more easily deformable than the other component. This means that, particularly when the closure element is in contact with the bearing device, the closure element, a component of the closure element, and/or the bearing device is elastically deformable. Due to the elastic deformability of at least one of the two aforementioned elements in contact with each other, a particularly secure bearing of the closure element on or against the bearing device can be achieved.

In a preferred embodiment, the closure element in particular may be formed from a material that has a higher elasticity, i.e., a lower modulus of elasticity, than the material from which the seat is formed. As described above, it is also possible that only one component of the closure element is formed from a material which has a higher elasticity than the material from which the seat is formed.

If the seat has a higher modulus of elasticity and is therefore more difficult to deform elastically than the closure element or than a component of the closure element which is in contact with the bearing device in the intermediate position, it may be further preferable that the bearing device is more difficult to deform than the closure element or than the component of the closure element which is in contact with the bearing device.

As an alternative to the preferred embodiment described above, in a further preferred embodiment, the bearing device may be formed from a material which has a higher elasticity than the material from which the closure element is formed. In this case, the seat may also be formed from a material which has a higher elasticity than the material from which the closure element is formed.

If one of the aforementioned elements is formed from a material with lower elasticity, this element may, for example, be formed from a metal, in particular steel. If one of the aforementioned elements is formed from a material with higher elasticity, this element may, for example, be formed from a plastic, in particular an elastomer.

Furthermore, in addition or alternatively, the component of the closure element that can be brought into contact with at least the bearing device and the bearing device can be designed with different stiffnesses.

Stiffness describes the deformability of the aforementioned elements, taking into account elasticity and geometric design. The geometric design, in particular, influences stiffness and thus deformability through the area moment of inertia. It is therefore also possible that a component made of a material with a low modulus of elasticity and a high area moment of inertia is more difficult to deform under higher forces than a component made of a material with a high modulus of elasticity and a low area moment of inertia.

In practice, it is possible that the bearing device and the closure element form at least two contact points spaced apart from each other when in contact with each other.

Due to the two or more contact points formed between the bearing device and the closure element in the intermediate position, which are spaced apart from each other, mechanical pressure generated during contact can be distributed well and/or the closure element can be mounted particularly securely on or against the bearing device.

Furthermore, due to the distance between the contact points, it is possible for the flowable medium to flow through a flow cross-section which is framed, for example, by the closure element, the seat, and the bearing device with the spaced-apart contact points.

Furthermore, in practice, it is possible for the closure element to be designed as a diaphragm, at least in sections, or to have a diaphragm.

In other words, the closure element can be designed as a diaphragm or have a section designed as a diaphragm. The diaphragm can be part of a one-piece closure element. Alternatively, it is also possible for the closure element to be designed in several parts, with a main body and a diaphragm arranged on the main body.

In particular, the diaphragm can contact the bearing device in the intermediate position.

A diaphragm is a thin, vibratory component. In particular, the diaphragm can be formed from a material that has high elasticity and/or a low moment of inertia, especially under bending stress. Furthermore, in particular, the material from which the diaphragm is formed may have a lower modulus of elasticity than a material from which the bearing device is formed. The diaphragm may, for example, be formed from a plastic, in particular an elastomer.

The closure element may be designed and arranged such that the closure element is attached to the diaphragm on a wall of the shut-off device, so that the closure element is movably connected to the wall within a range of movement of the vibratory diaphragm.

If the diaphragm is arranged on a main body of the closure element, the diaphragm may in particular be formed from a material which has a lower modulus of elasticity than the material from which the main body is formed.

In addition or alternatively, if the diaphragm is arranged on a main body of the closure element, the diaphragm and the main body may be movable relative to each other at least in sections. For example, the diaphragm may be connected locally to the main body, wherein the components of the diaphragm that are not connected to the main body are movable relative to the main body. For example, the diaphragm may be clamped with an edge section in a receptacle for the diaphragm formed on the main body. In addition or alternatively, the diaphragm may rest, in particular in a flat manner, against a section of the main body of the closure element formed parallel to this section, adjacent to the edge section, wherein this section of the diaphragm and this section of the main body are not connected to each other. This section of the diaphragm is therefore movable and, in particular, capable of oscillating.

The diaphragm may furthermore additionally or alternatively be formed on an outer edge of the closure part or be attached thereto. This outer edge may, for example, surround the main body circumferentially. The main body may in particular be movable transversely to a plane in which the diaphragm is arranged, because the diaphragm is capable of oscillating transversely to this plane.

In practice, the diaphragm of the closure element can be supported in the intermediate position between the bearing device and one or the main body of the closure element.

In particular, the diaphragm may be clamped in the intermediate position between the bearing device and the main body of the closure element. Preferably, the main body has one or the previously described section, to which one and in particular the described section of the diaphragm loosely abuts, wherein in particular this section has a lower deformability, i.e. a lower elasticity and/or a higher moment of inertia than the section of the diaphragm that abuts this section of the main body. This component of the main body may in particular be essentially plate-shaped.

In particular, as described, the bearing device may also have lower elasticity and/or higher stiffness than the diaphragm. This enables the diaphragm to be securely supported, in particular clamped.

In addition or alternatively, the diaphragm can at least partially rest against a section of the main body, which is formed in particular from a material with lower elasticity than the material from which the diaphragm is formed. This section of the main body can, for example, be a rear support for the diaphragm relative to the seat and/or, for example, the diaphragm can be supported at this section in the intermediate position of the closure element. In addition or alternatively, this section may have a higher stiffness than the diaphragm and/or be harder than the diaphragm.

In practice, the bearing device can be formed in one piece with the seat.

Due to the one-piece design of the bearing device with the seat, the bearing device is designed to be positionally fixed in relation to the seat. In particular, the seat and the bearing device can be sections or components of a common component of the shut-off device, for example a housing part of the shut-off device. The one-piece design means that the shut-off device can advantageously consist of only a few components. This is advantageous because it simplifies the assembly of the shut-off device and means that the shut-off device has a small number of potentially weak joints.

Alternatively, in practice, the bearing device can also be attached to one or more components that have a seat. This also ensures that the bearing device is fixed in position relative to the seat. In addition, this can simplify the manufacture of the bearing device and/or the component that has the seat.

In practice, the bearing device can be designed as a support with at least one contact surface aligned transversely to a direction of movement of the closure element.

For example, the bearing device can be designed as a stepped structure or a plurality of stepped structures.

Due to the at least one contact surface of the bearing device aligned transversely to the direction of movement of the closure element, the closure element can be brought into the intermediate position particularly easily by movement in the direction of movement between the open position and the closed position and can be supported there easily and securely on the at least one contact surface. If the closure element additionally has the plate-shaped section described here and the loosely adjacent section of the diaphragm described here, the section of the diaphragm can be clamped in the intermediate position, in particular between the contact surface aligned transversely to the direction of movement of the closure element and the plate-shaped section of the main element of the closure element.

In addition or alternatively, the bearing device may be designed as a support having at least one contact surface aligned parallel to a direction of movement of the closure element. In particular, if at least two spaced-apart contact points are formed between the bearing device and the closure element in the intermediate position, it is possible that the closure element and, in particular, the diaphragm are brought between the contact surfaces spaced apart parallel to the direction of movement and thus clamped when the closure element moves in the direction of movement.

In practice, in the intermediate position of the closure element, a first flow cross-section may be determined by the bearing device and a second flow cross-section may be determined by the closure element and the seat, wherein the first flow cross-section is larger than the second flow cross-section.

The second flow cross-section may be located downstream of a flow of a flowable medium in accordance with its intended use.

The first flow cross-section may in particular be formed by the bearing device, or at least by components of the bearing device, as well as by one or more components of the closure element adjacent to the bearing device and by the seat or a component of the component having the seat adjacent to the seat.

In particular, if the bearing device is designed as a stepped structure or a plurality of stepped structures, the stepped structure or plurality of stepped structures may be designed such that when the closure element is in the intermediate position, a flowable medium can flow through one or the flow cross-section described here, which is formed between at least two areas of the stepped structure or between at least two stepped structures. In particular, the closure element can rest against or on the stepped structure or stepped structures, in particular so that a closed flow cross-section is formed for the flowable medium. The sum of the flow cross-sections between each two areas of the stepped structure or between each two stepped structures can, in particular, be at least as large as and preferably larger than a flow cross-section formed in the intermediate position between the closure element and the seat. As a result, the flow rate in the intermediate position of the closure element is determined by the second flow cross-section between the closure element and the seat, even in the presence of the at least one stepped structure.

In practice, it may further be provided that the bearing device has a projection or a plurality of projections.

The projection or the plurality of projections may be designed in such a way that, when the closure element is in the intermediate position, a flowable medium can flow through one or more flow cross-sections described here, which are formed between the closure element and at least two areas of the projection or at least two projections. In particular, the closure element can rest against or on the projection or projections, in particular so that a closed flow cross-section is formed for the flowable medium. The sum of the flow cross-sections between each two areas of the projection or between each two projections can, in particular, be at least as large as and preferably larger than a flow cross-section formed in the intermediate position between the closure element and the seat. As a result, the flow rate in the intermediate position of the closure element is determined by the second flow cross-section between the closure element and the seat, even in the presence of at least one projection.

The projection or the plurality of projections may additionally or alternatively protrude in particular from one or the component having the seat in the direction of the closure element.

The projection or the plurality of projections may protrude from one or the component having the seat in the direction of the closure element, for example in a direction which is oriented parallel to the direction of movement of the closure element. In addition or alternatively, one or the projection or one or the plurality of projections may protrude from the component having the seat in a direction that is oriented diagonally and, in particular, orthogonally to the direction in which the closure element can move.

The projection or projections of the plurality of projections may, for example, be formed as a pin-shaped structure or as a plurality of pin-shaped structures. Alternatively, the projection or plurality of projections may at least comprise such structures.

If the bearing device is designed as a stepped structure or a plurality of stepped structures, the projections may, for example, protrude from the at least one stepped structure or rest against it in the intermediate position of the closure element. In these cases, the at least one stepped structure and the at least one projection in particular may be designed such that, when the closure element is in the intermediate position, a flowable medium can flow through one or the flow cross-section described here, which is formed between the closure element, at least two stepped structures, and at least two projections. In particular, the closure element can rest against or on the at least one stepped structure and/or the at least one projection, in particular so that a closed flow cross-section is formed for the flowable medium. The sum of the flow cross-sections between each two stepped structures and each two projections may, in particular, be at least as large as and preferably larger than a flow cross-section formed in the intermediate position between the closure element and the seat. As a result, the flow rate in the intermediate position of the closure element is determined by the second flow cross-section between the closure element and the seat, even in the presence of at least one stepped structure and at least one projection.

In practice, the closure element may have one or the described projection or one or the described plurality of projections.

The projection or the plurality of projections may protrude in particular from the closure element in the direction of the bearing device.

In particular, one or the diaphragm of the closure element may have one or the described projection or one or the described plurality of projections.

If the closure element has the projection or the plurality of projections, which are arranged in particular on the diaphragm and/or protrude in the direction of the bearing device, it is possible to support the closure element with the diaphragm by means of the projections on the bearing device. Thus, essentially the same effect can be achieved as with the projections provided on the bearing device described here. Reference is therefore also made explicitly to the description in connection with the projections on the bearing device.

In practice, the closure element can be detachably coupled to a control element. In particular, the coupling can be a mechanical coupling. A detachable coupling can be opened and closed.

In particular, the positions of the closure element can be predetermined using the control element. The control element can, for example, be a component of the adjustment mechanism and/or the adjustment device, or at least be mechanically connected to the adjustment mechanism and/or the adjustment device.

The detachable coupling of the closure element to the control element may in particular be such that there is a loose coupling at least in the intermediate position of the closure element. In addition or alternatively, the detachable coupling may be such that there is a fixed coupling in the open position and/or in the closed position of the closure element. A loose coupling means that the coupling can be released and closed either actively by an operator or passively by boundary conditions acting on the closure element and/or on the control element. A fixed coupling means that the closed coupling can be opened and closed actively, in particular by an operator, and not passively by boundary conditions acting on the closure element and/or the control element.

The detachable coupling, which is loose in particular in the intermediate position of the closure element, can be achieved, for example, by means of a form fit and/or a force fit.

Furthermore, in particular, the closure element and the control element can be held together directly or indirectly when the coupling is closed by means of a force acting preferably in the direction of movement of the closure element. In other words, the coupling can be closed or is closed when this force is applied. The coupling can in turn be open or is opened when this force is removed.

When the closure element and the control element are held directly against each other, these components are in direct contact with each other. When the closure element and the control element are held indirectly against each other, a further component may be arranged between the closure element and the control element, which in turn is in direct contact with the closure element and the control element when the coupling is closed.

A force holding the control element and the closure element together can, for example, be applied to the control element and/or the closure element by a mechanical spring and/or by a flowable medium to be controlled by the shut-off device. In addition or alternatively, this force can be applied electromagnetically.

Due to the coupling between the closure element and the control element described here, the position of the closure element can be changed by actuating the control element. The detachable coupling, which is loose in particular in the intermediate position of the closure element, is advantageous in particular for a certain class of valves, for example diaphragm valves with flow adjustment, in particular wherein the flow adjustment is effected by a variation of one or the opening stroke of the diaphragm. However, due to the detachable coupling, which is particularly loose in the intermediate position of the closure element, the cohesion between the control element and the closure element may be comparatively weak, so that they can move relative to each other, at least in the intermediate position of the closure element. If, as in the invention described here, the control element supports the closure element against the bearing device in the intermediate position, the movement between the control element and the closure element in the intermediate position is significantly reduced.

In practice, the shut-off device may have a compensating device.

The compensating device may, in particular, be a component of the actuating mechanism.

The compensating device may, for example, be formed between an operating element, which is operated by an operator to switch the shut-off device, and a control element, in particular the one described. The compensating device may be designed to transmit actuation of the operating element to the control element. For this purpose, the compensating device may have a receptacle in which one end of the control element or a component mechanically connected to the control element is held in a movably limited manner.

The mobility of the end of the control element or of the component mechanically connected to the control element in the receptacle may allow the operating element to be moved beyond one end of the adjustment range of the control element.

In practice, the shut-off device may comprise a main shut-off device and a pilot shut-off device. The main shut-off device may be designed as a shut-off device with the features described above and/or below. In addition or alternatively, the pilot shut-off device may be designed as a shut-off device with the features described above and/or below. In particular, the main shut-off device may be designed as a main valve and/or the pilot shut-off device may be designed as a pilot valve.

In practice, the shut-off device may comprise a first closure element, a first seat for the first closure element, a second closure element, a second seat for the second closure element, and at least one bearing device.

In particular, the first closure element and the first seat can form one or the main shut-off device described here, in particular the main valve, and/or the second closure element and the second seat can form one or the pilot shut-off device described here, in particular the pilot valve. For this purpose, the first closure element may be a main closure element and the first seat may be a main seat, more preferably a main valve seat. In addition or alternatively, the second closure element may be a pilot closure element and the second seat may be a pilot seat, more preferably a pilot valve seat.

The main shut-off device, in particular the main valve, can be used in particular to release, stop, and/or throttle the flow of a flowable medium through the opening adjacent to the main seat, in particular the main valve seat. The pilot shut-off device, in particular the pilot valve, can be used in particular to release, stop and/or throttle the flow of a flowable medium through an opening adjacent to the pilot seat, in particular the pilot valve seat.

With one and in particular the pilot shut-off device described here, in particular the pilot valve, it may be possible, for example, to use the flowable medium to move the main closure element into the open position, into the closed position and/or into the intermediate position. This can make switching the shut-off device particularly smooth.

The pilot closure element and the pilot seat, in particular the pilot valve seat, can be designed and arranged in such a way that the pilot closure element in its closed position contacts the pilot seat, which is designed in particular as a pilot valve seat, and closes the adjacent opening. In an open position of the pilot closure element, the pilot closure element can be spaced apart from the pilot seat, which is designed in particular as a pilot valve seat, and open the adjacent opening.

The pilot seat, in particular the pilot valve seat, and the adjacent opening may be arranged in particular on or in the main closure element.

The pilot shut-off device, in particular the pilot valve, makes it possible to create a pressure chamber that can be filled with the flowable medium. If an opening of the pressure chamber adjacent to the pilot seat, which is designed in particular as a pilot valve seat, is closed by the pilot closure element and the flowable medium flows into the pressure chamber through an open filling opening, pressure can be generated in the pressure chamber. If the opening of the pressure chamber adjacent to the pilot seat, which is designed in particular as a pilot valve seat, is not closed by the pilot closure element and the flowable medium flows out of the pressure chamber through this opening, pressure can be reduced in the pressure chamber. As a result, pressure in the pressure chamber can be adjusted by actuating the pilot shut-off device, in particular the pilot valve. This pressure can be used to control the main closure element.

If one or more of the control elements described is provided, the main shut-off device, in particular the main valve, and/or the pilot shut-off device, in particular the pilot valve, can be controlled by the control element.

The at least one bearing device can in particular determine the intermediate position of the main closure element, in particular wherein the main closure element contacts the bearing device in its intermediate position and/or is spaced apart from the main seat, which is in particular designed as a main valve seat.

In particular, the shut-off device may have at least two bearing devices. If the shut-off device has the main shut-off device, in particular the main valve, and the pilot shut-off device, in particular the pilot valve, a bearing device may be provided in each case on the main shut-off device, in particular on the main valve, and on the pilot shut-off device, in particular on the pilot valve. In this way, an intermediate position of the main closure element and the pilot closure element can be determined by a bearing device assigned to the respective closure element. Each of these at least two bearing devices can have some or all of the features described here.

In practice, the closure element can be movable along a longitudinal axis as intended.

In particular, the closure element may be movable along a longitudinal axis of a control element.

In addition or alternatively, the shut-off device may be designed as an adjustable throttle valve. The adjustable throttle valve may in particular be linearly adjustable.

If the shut-off device has a main shut-off device, in particular a main valve, and a pilot shut-off device, in particular a pilot valve, the main shut-off device may be designed as a throttle valve.

A throttle valve is understood to be a valve with which a flow rate of a flowable medium through an opening adjacent to the seat of the throttle valve can be variably adjusted. For this purpose, a closure element of the throttle valve can be movable, in particular linearly.

In practice, it may also be provided that the described actuating mechanism and/or the described adjustment device has/have a push-push locking mechanism.

The push-push locking mechanism may, for example, be a ballpoint pen mechanism or a heart curve mechanism. In particular, the push-push locking mechanism may be a component of the actuating mechanism.

### BRIEF DESCRIPTION OF THE DRAWINGS

The invention is now described in more detail on the basis of a few exemplary embodiments, but is not limited to these few exemplary embodiments. Further variants of the invention and exemplary embodiments result from combining the features of individual or multiple claims with each other and/or with individual or multiple features of the exemplary embodiments and/or the previously described variants of devices and uses according to the invention, wherein:

FIG. 1 shows a three-dimensional external view of a shut-off device described herein in an intermediate position,

FIG. 2 shows a longitudinal section of the shut-off device from FIG. 1 in a view of the section plane designated II in FIG. 1,

FIG. 3 shows a further sectional view of the area of the shut-off device designated III in FIG. 2 on a sectional plane rotated about the longitudinal axis,

FIG. 4 shows a detached component of the shut-off device from FIG. 1, having a bearing device, in a three-dimensional view, in a first embodiment,

FIG. 5 shows the component from FIG. 4 with a closure element attached to it according to a first embodiment, in a sectional view,

FIG. 6 shows the component from FIG. 4 with the closure element from FIG. 5 attached to it according to a first embodiment, in a three-dimensional view,

FIG. 7 shows a detached component of the shut-off device from FIG. 1, having a bearing device, in a three-dimensional view, in a second embodiment,

FIG. 8 shows the component from FIG. 7 with a closure element attached to it according to a second embodiment, in a sectional view,

FIG. 9 shows an isolated component of the shut-off device from FIG. 1, having a bearing device, in a three-dimensional view, in a third embodiment,

FIG. 10 shows the component from FIG. 9 with a closure element attached to it according to the first embodiment, in a sectional view,

FIG. 11 shows the component from FIG. 4 with a closure element attached to it according to a third embodiment, in a sectional view.

### DETAILED DESCRIPTION

In the following description of various objects and exemplary embodiments of the invention, elements that have the same function are given the same reference signs, even if their design or shape differs.

For clarity, not all reference signs are shown in the figures, although the elements may well be present in the figures. However, identical reference signs denote components and functional units that are identical in terms of function and/or design.

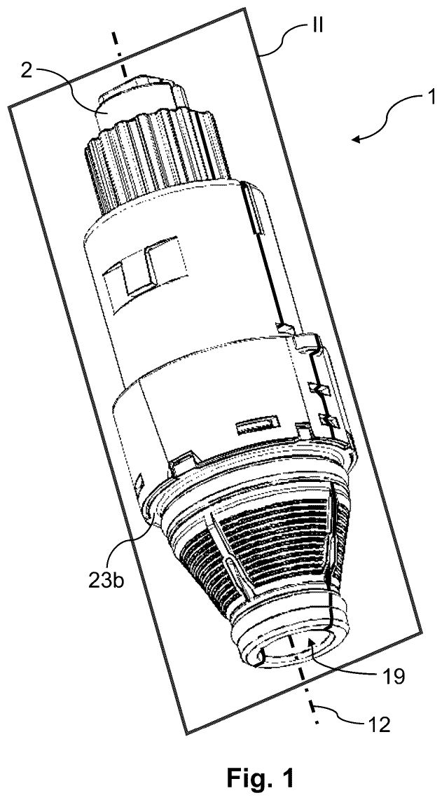

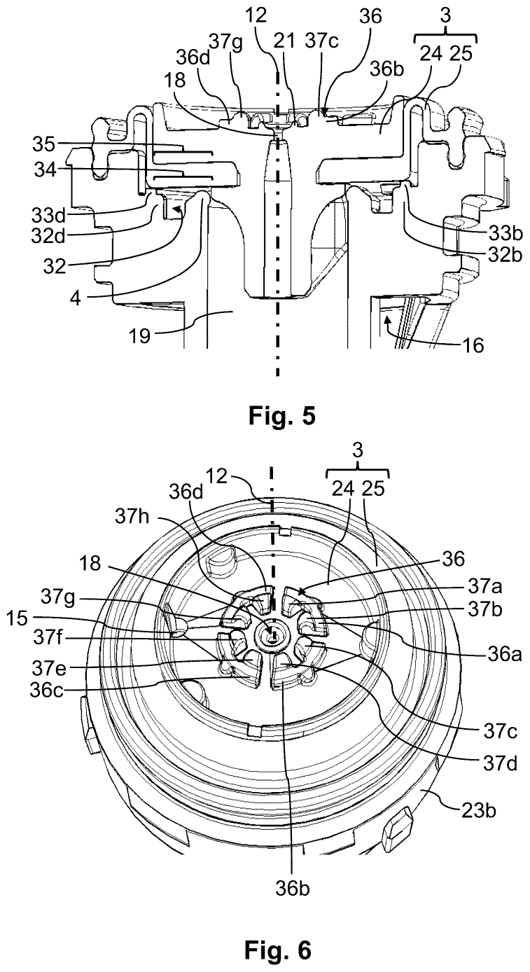

First, the general structure and mode of operation of an exemplary embodiment of a shut-off device according to the invention are described below, in particular with reference to FIGS. 1, 2, and 3. Subsequently, details of a bearing device and an intermediate position of the shut-off device are described, in particular in connection with FIGS. 5 and 6. FIGS. 1 to 6 show the same embodiment of the shut-off device described here for a flowable medium.

In the exemplary embodiment shown in FIGS. 1 to 6 and described here, the shut-off device 1 is designed as a valve 1.

The valve 1 can assume an open state, a closed state, and at least one intermediate state between the open state and the closed state. In the open state, the valve 1 can allow the maximum possible flow rate of a flowable medium. In the closed state, the valve 1 can prevent the flow of a flowable medium. In the intermediate state, valve 1 can allow a flow rate of a flowable medium that lies between the flow rate in the open state and the prevented flow in the closed state.

FIGS. 1 to 3 show valve 1 in the intermediate position.

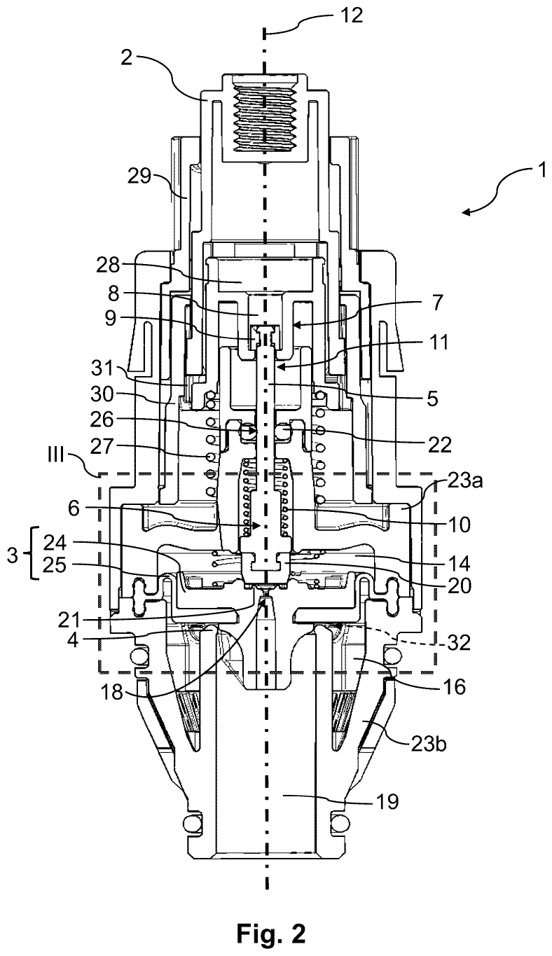

Switching between the states is performed by means of a manual operating element 2 of valve 1 shown in FIG. 1 and FIG. 2, wherein the manual operating element 2 serves to displace a first closure element 3 designed as a main closure element.

In a state of valve 1 not shown in the figures, the main closure element 3 of valve 1 rests in a sealing manner against a first seat 4 of valve 1 designed as a main valve seat. The main closure element 3 and the main valve seat 4 thus together form a main shut-off device designed as a main shut-off device. When valve 1 is switched from the closed state to the open state, the main closure element 3 is displaced so that it has a large, predefined distance from seat 4, in which a flow of a flowable medium is not or essentially not influenced by the main closure element 3.

A control element 5, which can be seen in particular in FIG. 2, is arranged between the manual operating element 2 and the main closure element 3, which transmits an operating movement exerted by an operator on the manual operating element 2 to the main closure element 3.

At a distal end 6 of the control element 5, relative to the position of the manual operating element 2, the control element 5 is coupled to the main closure element 3 in such a way that the main closure element 3 can be moved between the open position and the closed position with the control element 5. In particular, the distal end 6 of the control element 5 is movably engaged with the main closure element 3.

The coupling is, for example, detachable and, in particular, loose, so that in movable contact, a movement of the control element 5 in the direction of the main closure element 3 causes a displacement of the main closure element 3, and a movement of the main closure element 3 in the direction of the control element 5 causes a displacement of the main closure element 3. If the control element 5 moves in the opposite direction to the main closure element 3 and/or if the main closure element 3 moves in the opposite direction to the control element 5, the main closure element 3 and the control element 5 can be separated from each other.

This coupling can be advantageous for the functionality of the valve 1, as explained in the following description. Due to this coupling, the main closure element 3 and the control element 5 can be moved together or separately in different situations. The invention proposes, in particular, features with which noise development, particularly on the side of the main closure element 3, which is promoted by the separate movability of the main closure element 3 and the control element 5, can be reduced.

A compensating device 7, which can be seen in FIG. 2, is formed between the manual operating element 2 and the control element 5, which transmits the actuation of the manual operating element 2 to the control element 5.

For this purpose, the compensating device 7 has a receptacle 8 in which a plunger 9 is guided linearly in a sliding manner. This freedom of movement of the plunger 9 means that the control element 5 is movable relative to the manual operating element 2.

In order to hold the control element 5 in a preferred rest position relative to the manual operating element 2, a return element 10 is formed in the valve 1. This return element 10 develops a return force to hold the control element 5 in the rest position in the receptacle 8, provided that the position of this control element 5 allows this.

The return element 10 is arranged outside the compensating device 7 and, in particular, outside the receptacle 8. This prevents any obstruction of the sliding movement of the plunger 9 in the receptacle 8. The plunger 9, which is guided in the receptacle 8, is directly mechanically connected to the proximal end 11 of the control element 5 relative to the position of the manual operating element 2.

The receptacle 8 of the compensating device 7, on the other hand, is firmly connected to the manual operating element 2.

The longitudinal axis 12 of the valve 1 defines a plunger guide direction along which the plunger 9 is guided so that it can slide in the receptacle 8.

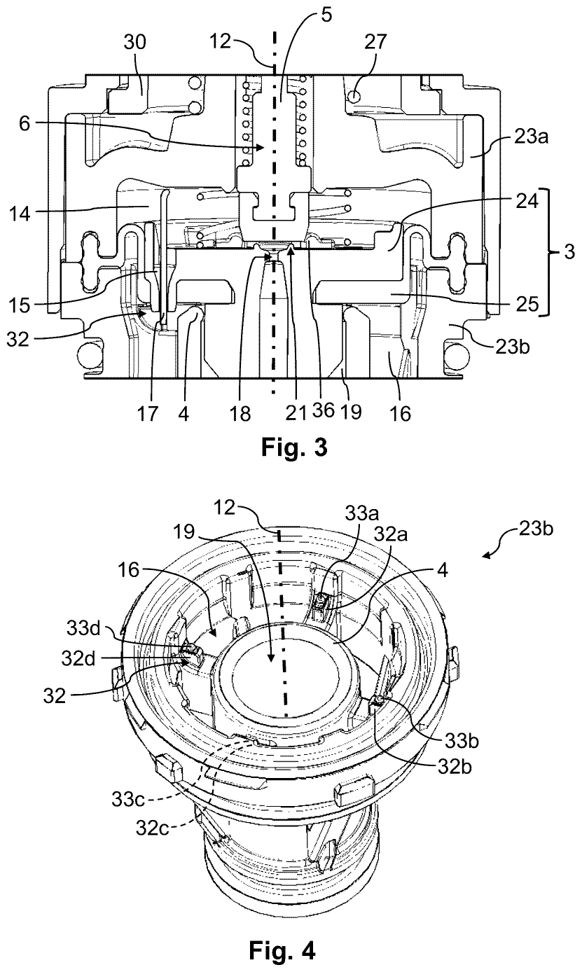

As can be seen in particular in FIG. 2 and FIG. 3, valve 1 has a pressure chamber 14 which is connected fluidically to an inlet 16 of valve 1 by a filling opening 15. A cleaning pin 17 is arranged in the filling opening 15 to prevent the filling opening from becoming clogged. The pressure chamber 14 is fluidically connected to a drain 19 of the valve via a drain opening 18.

The pressure chamber 14 is designed such that the control element 5 is arranged in the pressure chamber 14 with at least one section containing the distal end 6. The pressure chamber 14 is sealed against the manual operating element 2 and against a section of the control element 5 containing the proximal end 11 by a seal 22. The seal 22 rests against a component 23a of the valve 1, which is a housing part 23a of a housing of the valve 1.

The compensating device 7 is located in FIG. 2 above the seal 22 and consequently outside the pressure chamber 14. The control element 5 is arranged so that it can be displaced in the housing part 23a. When the valve 1 is switched, the seal 22 is moved along with the compensating device 7. The seal 22 is a sealing ring surrounding a passage opening 26 through which the control element 5 is guided in a sealing manner from the pressure chamber 14 to the outside, so that the pressure chamber 14 is closed at the top in the representation shown in FIG. 2.

On the side opposite the passage opening 26, the pressure chamber 14 is closed off by the main closure element 3. The main closure element 3 has a main body 24 and a diaphragm 25. The diaphragm 25 is designed to be essentially ring-shaped and is arranged with an inner edge in a sealing manner on a circumference of the main body 24. With an outer edge, the diaphragm 25 is arranged in a sealing manner on the components 23a, 23b designed as housing parts. The diaphragm 25 supports the main body 24 and the filling opening 15 formed on the main closure element 3. Due to the vibratory diaphragm, the main closure element 3 and, in particular, the main body 24 are capable of vibrating along the longitudinal axis 12, i.e., they are connected to the housing parts 23a, 23b in a movable manner.

The diaphragm 25 is clamped between the housing part 23a and the housing part 23b, in which the inlet 16 and the drain 19 are formed. It is also possible to design the housing of the valve 1 differently than with the two housing parts 23a, 23b and/or to attach the diaphragm 25 to the housing of the valve 1 in a sealing manner in another way.

The pressure chamber can therefore be closed, with the exception of the filling opening.

When a pressure of a flowable medium is applied in the inlet 16, the pressure chamber 14 is filled through the filling opening 15.

With the aid of the flowable medium and a pressure generated thereby in the pressure chamber 14, the main closure element 3 can be easily adjusted and thus the drain 19 can be fluidically separated from or connected to the inlet 16.

For this purpose, the control element 5 is connected at its distal end 6, relative to the position of the manual operating element 2, to a second closure element 20. The second closure element 20 is designed as a pilot closure element.

Corresponding to the pilot closure element 20, the drain opening 18 is formed in the main closure element 3. The drain opening 18 is surrounded by a second seat 21 of the valve 1, which is designed as a pilot valve seat. In the area of the pilot valve seat 21, the drain opening has a cross-section that is larger than a cross-section of the filling opening 15, as shown in particular in FIG. 3. The pilot closure element 20 and the pilot valve seat 21 together form a pilot shut-off device designed as a pilot valve. The drain opening 18 can thus be closed with the pilot closure element 20 when the pilot closure element 20 rests against the pilot valve seat 21, or opened, i.e., releasable, when the pilot valve 20 does not rest against the pilot valve seat 21.

The pilot closure element 20 can thus be used to control whether pressure builds up in the pressure chamber 14 through the filling opening 15, which is the case when the drain opening 18 is closed, or whether this built-up pressure is released again by the pilot closure element 20 opening the drain opening 18.

To make switching the valve 1 particularly easy, the cross-section of the drain opening 18 that can be covered by the pilot closure element 20 is large enough that the pilot closure element 20 with the control element 5 is driven by internal pressure in the pressure chamber 14 in the direction of a closed position in which the drain opening 18 is closed.

This is achieved in particular by the fact that the cross-sectional area of the drain opening 18 that can be covered by the pilot closure element 20 is larger than a cross-sectional area of the control element 5 at its exit from the pressure chamber 14, i.e., in the area of the passage opening 26. Due to the larger cross-sectional area at the drain opening 18, a flowable medium in the pressure chamber 14 ultimately presses the control element 5 with greater force in the direction of the drain opening 18.

This means that the return element 10, which also drives the control element 5 in the direction of the drain opening 18, can be dimensioned with a comparatively low spring force. This allows the manual operating element return spring 27, which drives the control element 5 in the opposite direction to the drain opening 18 via the actuating element 2 and the plunger 9, to also be dimensioned with a comparatively low spring force. In this way, smooth switching behavior can be achieved.

The states of the valve and the switching of the valve between the states are summarized again below.

When pressure builds up in the pressure chamber 14, the main closure element 3 is pressed against the main valve seat 4, thereby separating the inlet 16 from the drain 19. The drain 19 is then sealed off from the inlet 16. The valve 1 is then in the closed state not shown in the figures.

When the pressure chamber 14 is relieved, i.e., when the drain opening 18 is open, the pressure in the inlet 16 causes the main closure element 3 to be pushed away from the inlet 16 and the main valve seat 4 and releases the fluid connection to the drain 19. The main closure element 3 can then be in the above-mentioned open position, in which the flow of a flowable medium from the inlet 16 to the drain 19 is not or essentially not influenced by the main closure element 3. The open position of the main closure element 3 is not shown in the figures.

It can be seen from the figures that the drain opening 18 and the drain 19 are arranged one behind the other in an extension of the control element 5 along the longitudinal axis 12, i.e., along the direction of adjustment of the control element 5.

The return element 10 is designed as a coil spring and acts on the control element 5 under pressure. The return element 10 is supported on the housing part 23a.

The manual operating element 2 is acted upon by a manual operating element return spring 27, which is also supported on the housing part 23a. To enable the manual operating element 2 to move the control element 5 into the open position, which opens the drain opening 18, the manual operating element return spring 27 is designed to develop a greater force than the return element 10.

Both the return element 10 and the manual operating element return spring 27 are designed as coil springs that surround and accommodate the control element 5.

The compensating device 7 is arranged along the longitudinal axis 12 above the manual operating element return spring 27.

The manual operating element 2 is hood-shaped and accommodates the compensating device 7 in its interior 28, as can be seen in FIG. 2.

The manual operating element 2 is held in a first sleeve 29 and a second sleeve 30. The second sleeve 30 is partially inserted into the first sleeve 29 and can rotate around the longitudinal axis 12 in the first sleeve 29. The first sleeve 29 and the second sleeve 30 are each fixed in the longitudinal axis 12 and each form a stop for the manual operating element 2.

The valve 1 has a bistable actuating mechanism 31 which forms a push-push locking mechanism, for example a ballpoint pen mechanism or a heart-shaped cam mechanism. With the actuating mechanism 31, the manual operating element 2 on the second sleeve 30 can be adjusted between an upper position, in which the main closure element 3 can assume the open position, and a lower position, in which the main closure element 3 can assume the closed position, by pressing along the longitudinal axis 12.

The valve 1 also has an adjustment device, which is not visible in FIG. 2. The adjustment device can be used to adjust the maximum distance, i.e., a distance between the pilot closure element 20 and the stop on the first sleeve 29 for the manual operating element 2, when the control element 5 is extended to its maximum position in the direction of the drain opening 18.

The adjustment device is designed as a combination of a tooth profile and a plurality of shoulders sliding along the tooth profile. The tooth profile forms the aforementioned stop in the first sleeve 29 for the manual operating element 2. In the embodiment described here, the tooth profile is designed as a sawtooth profile at the upper end of the radially inward-facing inner side of the first sleeve 29. The shoulders are formed as pins movable along the tooth profile on the radially outward-facing outer side of the manual operating element 2. The manual operating element 2 can be displaced along the longitudinal axis 12 with the adjustment mechanism 31 and is additionally arranged to be rotatable or pivotable about the longitudinal axis 12 with the adjustment device.

In order to switch from an open state of the valve 1 (not shown in the figures) to a closed state of the valve 1 (also not shown), in which the main closure element 3 rests tightly against the main valve seat 4, the manual operating element 2 can be pressed and adjusted along the longitudinal axis 12 by means of the actuating mechanism 31.

By pressing the manual operating element 2 when valve 1 is open, the pilot closure element 20 is pressed against the pilot valve seat 21 by means of the manual operating element 2 and the main closure element 3 is pressed against the main valve seat 4. This builds up pressure in the pressure chamber 14, which presses the pilot closure element 20 against the pilot valve seat 21 and the main closure element 3 against the main valve seat 4 even when the manual operating element 2 is released, thus keeping the valve 1 in the closed state.

To return the valve 1 from the closed state to the open state, the manual operating element 2 can be pressed again along the longitudinal axis 12.

Pressing the manual operating element 2 along the longitudinal axis 12 causes the receptacle 8 to move downwards relative to the plunger 9.

The mobility of the plunger 9 in the holder 8 allows the manual operating element 2 to be moved beyond an end of the adjustment path for the control element 5 specified by the pilot closure element 20. This is advantageous in a push-push locking mechanism, as it allows the lower dead center (in relation to the push movement) or stable point to be exceeded in order to return the manual operating element 2 from a lower position to an upper position.

When the manual operating element 2 is moved to the upper position, it takes the plunger 9 and the control element 5 with it. This is because the plunger 9 connected to the control element 5 has a larger cross-section than a passage opening for the control element 5 in a lower contact surface of the receptacle 8 through which the control element 5 is guided into the receptacle 8. The plunger 9 can thus rest against the lower contact surface of the receptacle 8 and be moved upward when the manual operating element 2 is moved to the upper position.

In this situation, the pilot closure element 20 releases the drain opening 18. However, since pressure is still built up in the pressure chamber 14, the main closure element 3 initially remains in its closed position.

However, as already mentioned, the drain opening 18 is of larger dimension than the filling opening 15, so that the pressure in the pressure chamber 14 is reduced via the drain opening 18 and the drain 19.

This causes the pressure in the inlet 16 to lift the main closure element 3 with the diaphragm 25, so that the inlet 16 and the drain 19 are connected fluidically.

In order to switch valve 1 from the open state to the state shown in FIG. 2 and FIG. 3, the position of the manual operating element 2 can be changed using the adjustment device.

In the state shown in FIG. 2 and FIG. 3, there is a small gap between the main closure element 3 and the main valve seat 4, as well as between the pilot closure element 20 and the pilot valve seat 21. The main closure element 3 is arranged in an intermediate position set by the adjustment device, in which the main closure element 3 is detached from the drain 19 in order to release it in a throttled manner.

When the manual operating element 2 with the pins formed thereon is rotated about the longitudinal axis 12, the pins move downwards or upwards on the tooth profile in the first sleeve 29, thereby moving the manual operating element 2 with them. This means that a maximum distance between the main valve seat 4 and the distal end 6 of the control element 5, i.e., a distance between the main valve seat 4 on the one hand and the distal end 6 or the pilot closure element 20 attached to it on the other hand, can be adjusted when the valve 1 is not in the closed state. An opening cross-section at the main valve seat 4, through which a flowable medium can flow from the inlet 16 into the drain 19, can thus be varied.

If the pilot closure element 20 is moved closer to the drain opening 18 compared to the open state of the valve 1, this can lead to a brief closure of the drain opening 18 and thus to a renewed build-up of pressure in the pressure chamber 14. Since the manual operating element 2 is still in its upper position, the main closure element 3 is not pressed against the main valve seat 4 by the build-up of pressure, but is only pressed down until the drain opening 18 is open again. This is because the pilot closure element 20 cannot follow the main closure element 3 any further due to the position of the manual operating element 2 until the latter reaches the main valve seat 4.

In this open state of the pilot valve, the pressure chamber 14 is relieved again, so that the main closure element 3 again tends to move upwards. This results in a floating equilibrium state in which the main closure element 3 is positioned in an intermediate position and in which the inlet 16 is partially open, so that a reduced flow between the inlet 16 and the drain 19 is established compared to the open position of the main closure element 3. This achieves a reduced maximum distance between the main valve seat 4 and the distal end 6 of the control element 5 as compared to the open state of the valve 1.

As a result, valve 1 has been transferred from the open state to the state shown in FIG. 2, in which the main closure element 3 is arranged in the intermediate position, in the manner described here.

In order to limit or even prevent noise generation in the state shown in FIG. 2 with the main closure element 3 in the intermediate position, the valve 1 has a first bearing device 32, which is contacted by the main closure element 3 in an intermediate position of the main closure element 3, and a second bearing device 36, which is contacted by the pilot closure element 20 in an intermediate position of the pilot closure element 20.

The first bearing device 32 of the exemplary embodiment of valve 1 shown in FIGS. 1 to 6 is particularly clearly visible on the housing part 23b shown in isolation in FIG. 4, which has the main valve seat 4, of the same exemplary embodiment.

The second bearing device 36 of the exemplary embodiment of valve 1 shown in FIGS. 1 to 6 can be seen particularly well on the closure element 3 shown in FIG. 6, which has the pilot valve seat 4, of the same exemplary embodiment.

For a better understanding of the functionality of the bearing devices 32, 36 of the exemplary embodiment shown in FIGS. 1 to 6, FIGS. 5 and 6 show an upper portion of the housing part 23b and the main closure element 3 arranged in the intermediate position. The intermediate position of the main closure element 3 is determined by the first bearing device 32.

In the exemplary embodiment of the valve 1 shown in FIGS. 1 to 6, the main closure element 3 has, as described, the main body 24 and the diaphragm 25, and the main closure element 3 contacts the first bearing device 32 in the intermediate position with the diaphragm 25, in that the diaphragm 25 rests on the first bearing device 32.

As described, the diaphragm 25 is in particular formed to be essentially annular and is arranged with its inner edge in a sealing manner against a circumference of the main body 24. For this purpose, the diaphragm 25 is in particular pressed in a sealing manner into a recess formed in the main body 24. The outer edge of the diaphragm 25 is arranged in a sealing manner on the housing parts 23a, 23b. With a radially central section 34 formed between the inner edge and the outer edge of the diaphragm 25, the diaphragm 25 rests loosely on a radially outer section 35 of the main body 24 formed parallel to the central section 34. The radially central section 34 and the radially outer section 35 are aligned transversely to the longitudinal direction 12 and to the direction of movement of the main closure element 3, respectively.

The diaphragm 25 may in particular be formed from an elastic material with a low modulus of elasticity, for example from an elastomer. The main body 24 can be formed in particular from a material that has a higher modulus of elasticity than the material from which the diaphragm 25 is formed, for example from a metallic material. The main body 24 shown is thus more difficult to deform elastically than the diaphragm 25 shown.

In the exemplary embodiment shown in FIGS. 1 to 6, the first bearing device 32 is designed as a support with four essentially stepped structures 32a, 32b, 32c, 32d. The stepped structures 32a, 32b, 32c, 32d are arranged equidistantly on a circular path, which is located outside the main valve seat 4.

As can be seen in particular in FIG. 4 and FIG. 5, the essentially stepped structures 32a, 32b, 32c, 32d are formed integrally with the housing part 23b having the main valve seat 4 on an inwardly facing inner wall of the housing part 23b. Alternatively, it is also possible for the first bearing device 32 and, in particular, the stepped structures to be attached to the housing part 23b (not shown in the figures).

The stepped structures 32a, 32b, 32c, 32d have a surface aligned transversely to the direction of movement of the closure element 3, i.e., to the longitudinal axis 12. Pin-shaped projections 33a, 33b, 33c, 33d are formed on these surfaces of each of the stepped structures, which protrude from the housing part 23b and, in particular, from the stepped structures 32a, 32b, 32c, 32d in the direction of the main closure element 3 and, in particular, in the direction of the middle section 34 of the diaphragm 25. The projections 33a, 33b, 33c, 33d each also have a surface aligned transversely to the direction of movement of the closure element 3. These surfaces of the pin-shaped projections 33a, 33b, 33c, 33d are arranged closer to the distal end 6 of the control element 5 along the longitudinal axis 12 than the main valve seat 4. In contact with the main closure element 3, these surfaces of the pin-shaped projections 33a, 33b, 33c, 33d are contact surfaces, and the diaphragm 25 rests on these contact surfaces.

The housing part 23b and the first bearing device 32 can in particular be formed from a material that has a higher modulus of elasticity than the material from which the diaphragm 25 is formed, for example from a metallic material. The diaphragm 25, which is a component of the main closure element 3 that can be brought into contact with the first bearing device 32, and the first bearing device 32 are thus designed with different elasticities. The higher elasticity of the diaphragm 25 allows the diaphragm 25 to be deformed and pressed against the main valve seat 4 in order to move the main closure element 3 into the closed position. The first bearing device 32 is then pressed into the diaphragm 25.

When the main closure element 3 is in the intermediate position with the diaphragm 25 resting on the first bearing device 32, i.e. on the projections 33a, 33b, 33c, 33d, the first bearing device 32 and the main closure element 3 form four contact points spaced apart from each other, so that the main closure element 3 is mounted securely and with reduced vibration compared to an embodiment of the valve (not shown) in which the first bearing device is not provided.

A space is formed between each two adjacent stepped structures 32a, 32b, 32c, 32d with projections 33a, 33b, 33c, 33d arranged thereon, which in the intermediate position of the main closure element 3, in particular in cooperation with the main valve seat 4, forms a flow cross-section for a flowable medium. The sum of these flow cross-sections thus formed is greater than the flow cross-section formed between the main closure element 3 and the main valve seat 4 parallel to the longitudinal axis 12. As a result, the flow rate through the drain 19 is limited by the flow cross-section between the main closure element 3 and the main valve seat 4.

Due to the described design, the main closure element 3 is mounted on the first bearing device 32 in the intermediate position and the diaphragm 25 is arranged between the first bearing device 32 and the main body 24 in a supported manner and, in particular, clamped. Due to the elasticity of the diaphragm 25, the main closure element 3 remains movable and limited in its movement, and in particular capable of oscillating, even in contact with the first bearing device 32 along the longitudinal axis 12.

In order to additionally or alternatively limit or even prevent noise generated by the control element 5 or the pilot closure element 20, the valve 1 has a second bearing device 36, which can be contacted by the pilot closure element 20.

As can be seen in particular in FIG. 5 and FIG. 6, the second bearing device 36 in the exemplary embodiment shown in FIG. 1 to FIG. 6 is designed as a support with, for example, four essentially stepped structures 36a, 36b, 36c, 36d. The stepped structures 36a, 36b, 36c, 36d are formed integrally with the main body 24 of the main closure element 3 and are arranged in particular equidistantly on a circular path. This circular path has a radius that is greater than the radius of the pilot valve seat 21 and smaller than the radius of the main valve seat 4. In other words, the circular path with the stepped structures 36a, 36b, 36c, 36d of the second bearing device 36 is arranged outside the pilot valve seat 21 and inside the main valve seat 4.

In the exemplary embodiment shown, the stepped structures 36a, 36b, 36c, 36d each consist of a flat section with a square cross-section. In the top view, the stepped structures 36a, 36b, 36c, 36d are designed in a partial circle shape. Two semicircular projections 37a, 37b, 37c, 37d, 37e, 37f, 37g, 37h protrude from each of the stepped structures 36a, 36b, 36c, 36d in the direction of the pilot closure element 20. The projections 37a, 37b, 37c, 37d, 37e, 37f, 37g, 37h on the second bearing device 36, like the projections on the first bearing device 32, have a surface aligned transversely to the direction of movement of the closure element 3, i.e., to the longitudinal axis 12. These surfaces are arranged closer to the distal end 6 of the control element 5 along the longitudinal axis 12 than the pilot valve seat 21. In contact with the pilot closure element 20, these surfaces of the projections 37a, 37b, 37c, 37d, 37e, 37f, 37g, 37h are contact surfaces, and the pilot closure element 20 rests on these contact surfaces.

In this case, a free space is formed between each two adjacent stepped structures 36a, 36b, 36c, 36d and between each two adjacent projections 37a, 37b, 37c, 37d, 37e, 37f, 37g, 37h, which forms a flow cross-section for a flowable medium in the intermediate position of the pilot closure element 20, in particular in cooperation with the main body 24. The sum of these flow cross-sections thus formed is greater than the flow cross-section formed between the pilot closure element 20 and the pilot valve seat 21 parallel to the longitudinal axis 12. As a result, the flow rate through the drain opening 18 is limited by the flow cross-section between the pilot valve seat 21 and the main body 24.

The main body 24 and the second bearing device 36 can be formed in particular from a material that has a higher modulus of elasticity than the material from which the pilot closure element 20 is formed, for example from a metallic material. The pilot closure element 20 and the second bearing device 36 are thus designed with different elasticities. The higher elasticity of the pilot closure element 20 allows the pilot closure element 20 to be deformed and pressed against the pilot valve seat 21 in order to move the pilot closure element 20 into a closed position. The second bearing device 36 is then pressed into the pilot closure element 20 and the pilot closure element 20 rests against the pilot valve seat 21. In the open position of the main closure element 3, the second bearing device 36 can rest against the pilot closure element 20, depending on whether or not the diaphragm 25 allows the main closure element 3 to move up to the pilot closure element 3. In the intermediate position of the main closure element 3, the second bearing device 36 is contacted at least temporarily by the pilot closure element 20.

When the pilot closure element 20 rests on the second bearing device 36 with, for example, the four stepped structures 36a, 36b, 36c, 36d and the eight projections 37a, 37b, 37c, 37d, 37e, 37f, 37g, 37h, the second bearing device 36 and the pilot closure element 20 form, for example, eight contact points spaced apart from one another, so that the main closure element 3 is mounted securely and with reduced vibration compared to an embodiment of the valve (not shown) in which the second bearing device is not provided.

Further embodiments of a shut-off device designed as a valve are described below with reference to the figures. Due to the strong similarities between the further embodiments and the exemplary embodiment shown in FIGS. 1 to 6, only the differences from the exemplary embodiment shown in FIGS. 1 to 6 are described.

These differences relate in particular to the design of the main closure element 3 and the design of the first bearing device 32.

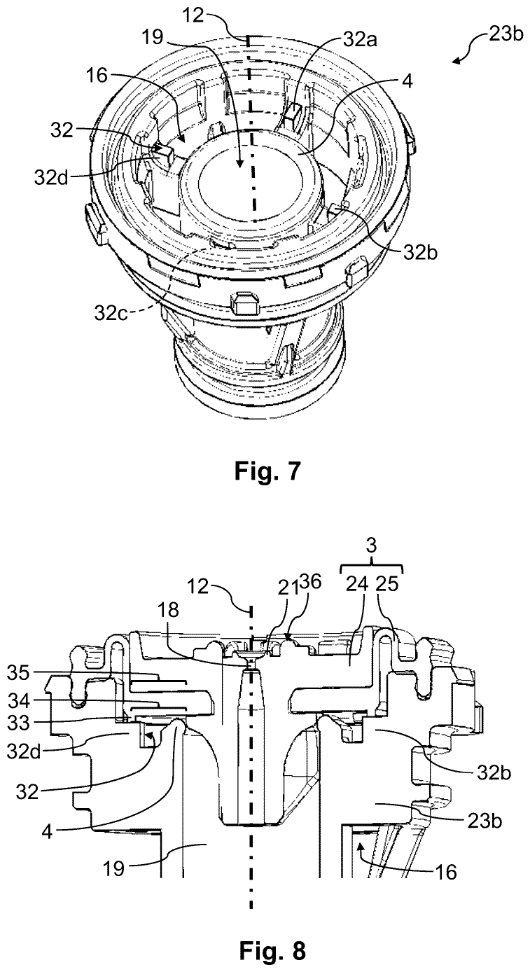

FIGS. 7 and 8 show components of an exemplary embodiment of the valve in which the first bearing device 32 is designed in the form of a support with four stepped structures 32a, 32b, 32c, 32d, as in the exemplary embodiment shown in FIGS. 1 to 5. The stepped structures 32a, 32b, 32c, 32d have a surface aligned transversely to the direction of movement of the closure element 3, i.e., to the longitudinal axis 12. These surfaces are arranged along the longitudinal axis 12 at a greater distance from the distal end 6 of the control element 5 than the main valve seat 4. Alternatively, these surfaces may also have the same distance as the main valve seat 4.

In contact with the main closure element 3, the surfaces of the stepped structures 32a, 32b, 32c, 32d aligned transversely to the direction of movement of the closure element 3 are contact surfaces, and the diaphragm 25 rests on these contact surfaces.

Unlike in the exemplary embodiment described in FIGS. 1 to 5, the stepped structures 32a, 32b, 32c, 32d do not have any projections here. However, the diaphragm 25 has a projection 33, which is designed in particular as a ring, which protrudes from the main closure element 3 in the direction of the second bearing device 32. The projection 33 could also be designed differently than as a ring, for example as a pin and/or crenellated shape. Due to the projection 33 formed on the diaphragm 25, the main closure element 3 and the first bearing device 32 can be in contact in the intermediate position of the main closure element 3 shown in FIG. 8 when the main closure element 3 and the main valve seat 4 are spaced apart.

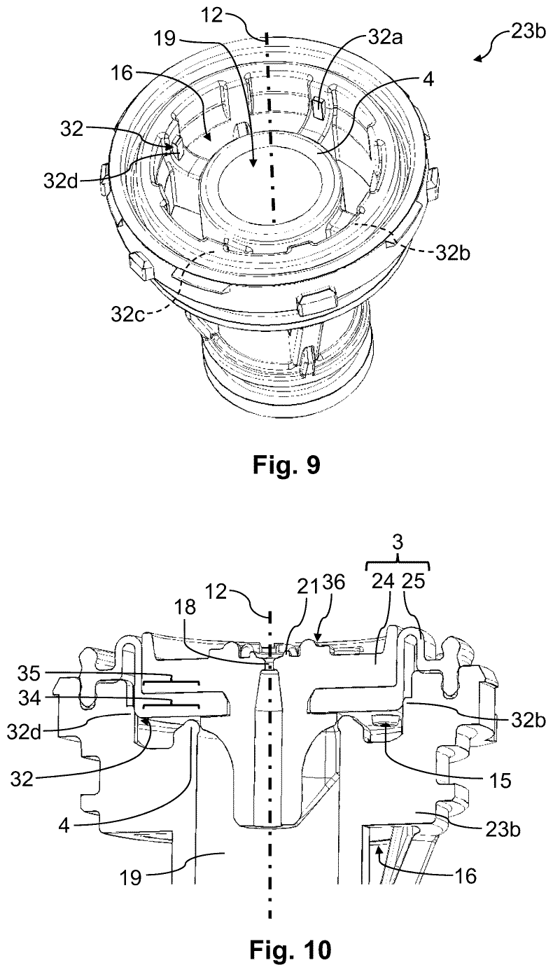

FIG. 9 and FIG. 10 show components of a further exemplary embodiment of the valve. In this exemplary embodiment, too, the first bearing device 32 is formed in the shape of four stepped structures 32a, 32b, 32c, 32d. The stepped structures 32a, 32b, 32c, 32d and the main closure element 3 are designed and arranged such that the main closure element 3 rests against a radially inward-facing surface of the stepped structures 32a, 32b, 32c, 32d in the intermediate position of the main closure element 3 shown in FIG. 10.

The first bearing device 32 thus has a contact surface aligned parallel to a direction of movement of the main closure element 3. The surfaces on the stepped structures 32a, 32b, 32c, 32d have at least one section along the longitudinal axis 12 that is closer to the distal end 6 of the control element 5 than the main valve seat 4. In this embodiment, it is therefore possible to dispense with projections on the first bearing device 32 or the main closure element 3.

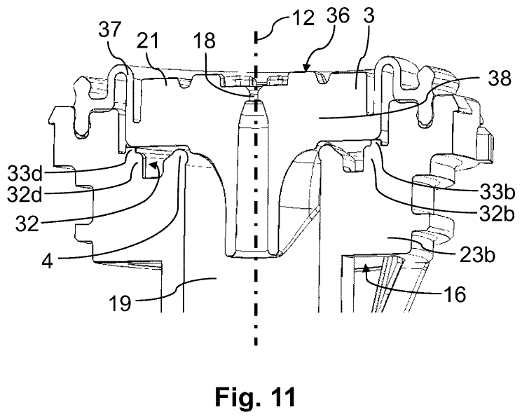

FIG. 11 shows components of yet another exemplary embodiment of the valve. The housing part 23b and, in particular, the first bearing device 32 are essentially identical to the corresponding components of the embodiment of the valve shown in FIGS. 1 to 5.

The main closure element 3 is designed differently from the main closure element shown in FIGS. 1 to 5. In particular, the main closure element 3 shown in FIG. 11 is designed as a single piece. The main closure element 3 shown has a thin-walled section 38, so that the main closure element 3 is designed in sections with this section 38 as a vibrating diaphragm. The thin-walled section 38 essentially has the geometry of the diaphragm shown in FIGS. 1 to 5. A thick-walled section 39, to which the thin-walled section 38 is adjacent, essentially has the geometry of the main body shown in FIGS. 1 to 5 and fulfills its function.

The main closure element 3 shown in FIG. 11 can, for example, be formed from an elastic material with a low modulus of elasticity, for example from an elastomer.

The housing part 23b and the first bearing device 32 can in particular be formed from a material that has a higher modulus of elasticity than the material from which the main closure element 3 is formed, for example from a metallic material. The main closure element 3 and the first bearing device 32 are thus designed with different elasticities. The higher elasticity of the main closure element 3 allows it to be deformed and pressed against the main valve seat 4 in order to move the main closure element 3 into the closed position. The first bearing device 32 is then pressed into the main closure element 3.

### LIST OF REFERENCE SIGNS

1 Shut-off device/valve
2 Manual operating element
3 Closure element/main closure element
4 Seat/main valve seat
5 Control element
6 Distal end
7 Compensating device
8 Receptacle
9 Plunger
10 Return element
11 Proximal end
12 Longitudinal axis
14 Pressure chamber
15 Filling opening
16 Inlet
17 Cleaning pin/end of support spring
18 Drain opening
19 Drain
20 Second closure element, pilot closure element
21 Second valve seat, pilot valve seat
22 Seal
23a Housing part
23b Housing part
24 Main body
25 Diaphragm
26 Passage opening
27 Manual operating element return spring
28 Interior of the manual operating element
29 First sleeve
30 Second sleeve
31 Adjustment mechanism
32 First bearing device
32a, 32b, 32c, 32d Stepped structures
33, 33a, 33b, 33c, 33d Projection
34 Radial middle section of the diaphragm
35 Radial outer section of the main body
36 Second bearing device
36a, 36b, 36c, 36d stepped structures
37a, 37b, 37c, 37d, 37e, 37f, 37g, 37h Projection
38 Thin-walled section
39 Thick-walled section

1. A shut-off device (1) for a flowable medium, the shut-off device (1) comprising:
at least one closure element (3, 20) that is movable into an open position and into a closed position;
a seat (4, 21) for the at least one closure element (3, 20); and
a bearing device (32, 36) that determines an intermediate position of the closure element (3, 20), wherein, in the intermediate position, the closure element (3, 20) at least one of contacts the bearing device (32, 36) or is spaced apart from the seat (4, 21).

2. The shut-off device (1) according to claim 1, further comprising at least one of an actuating mechanism (31) or an adjustment device with which the closure element (3, 20) or a component of the closure element (3, 20) is adapted to be brought to an adjustable distance from the seat (4, 21).

3. The shut-off device (1) according to claim 2, wherein the component of the closure element (3, 20) that is adapted to be brought into contact with the bearing device (32, 36) and the bearing device (32, 36) are designed with at least one of a different elasticity or stiffness.

4. The shut-off device (1) according to claim 1, wherein that the bearing device (32, 36) and the closure element (3, 20) form at least two contact points spaced apart from each other when in contact with each other.

5. The shut-off device (1) according to claim 1, wherein the closure element (3, 20) is designed at least in sections as a diaphragm (25) or has a diaphragm (25).

6. The shut-off device (1) according to claim 5, wherein the diaphragm (25) contacts the bearing device (32, 36) in the intermediate position.

7. The shut-off device (1) according to claim 5, wherein diaphragm (25) of the closure element (3, 20) is arranged supported in the intermediate position between the bearing device (32, 36) and a main body (24) of the closure element (3, 20).

8. The shut-off device (1) according to claim 1, wherein the bearing device (32, 36) is formed integrally with a component (23b, 3) having the seat (4, 21) or is attached to the component (23b, 3) having the seat (4, 21).

9. The shut-off device (1) according to claim 1, wherein the bearing device (32, 36) is configured as a support with at least one contact surface aligned transversely or parallel to a direction of movement of the closure element (3, 20).

10. The shut-off device (1) according to claim 1, wherein, in the intermediate position of the closure element (3, 20), a first flow cross-section is determined by the bearing device (32, 36) and a second flow cross-section is determined by the closure element (3, 20) and the seat (4, 21), and the first flow cross-section is larger than the second flow cross-section.

11. The shut-off device (1) according to claim 8, wherein the bearing device (32, 36) has a projection or a plurality of projections (33a, 33b, 33c, 33d, 37a, 37b, 37c, 37d, 37e, 37f, 37g, 37h).

12. The shut-off device (1) according to claim 11, wherein the projection or plurality of projections (33a, 33b, 33c, 33d, 37a, 37b, 37c, 37d, 37e, 37f, 37g, 37h) protrude from the component (23b, 3) having the seat (4, 21) in a direction of the closure element (3, 20).

13. The shut-off device (1) according to claim 1, wherein the closure element (3, 20) has a projection (33) or a plurality of projections, and the projection (33) or the plurality of projections protrudes from the closure element (3, 20) in a direction of the bearing device (32, 36).

14. The shut-off device (1) according to claim 13, wherein the closure element (3, 20) includes a diaphragm (25) of the closure element (3, 20), and the projection (33) or the plurality of projections protrudes from the diaphragm (25).

15. The shut-off device (1) according to claim 1, wherein the closure element (3, 20) is detachably coupled to a control element (5), and the positions of the closure element (3, 20) are predeterminable with the control element.

16. The shut-off device (1) according to claim 1, further comprising a compensating device (7).

17. The shut-off device (1) according to claim 1, wherein the shut-off device (1) comprises a main shut-off device and a pilot shut-off device, and at least one of the main shut-off device or the pilot shut-off device is configured as the shut-off device according to claim 1.

18. The shut-off device (1) according to claim 1, wherein the at least one closure element (3, 20) includes a first closure element (3), and the seat comprises a first seat (4) for the first closure element (3), and the at least one closure element (3, 20) includes a second closure element (20), a second seat (21) for the second closure element (20), wherein at least one of a) the first closure element (3) and the first seat (4) form a main shut-off device, or b) the second closure element (20) and the second seat (21) form a pilot shut-off device.

19. The shut-off device (1) according to claim 1, wherein at least one of a) the closure element (3, 20) is movable along a longitudinal axis (12), or b) the shut-off device (1) is configured as a throttle valve that is linearly adjustable.

20. The shut-off device (1) according to claim 2, wherein the at least one of the actuating mechanism (31) or the adjustment device has a push-push locking mechanism.
